(19) United States
(12) Patent Application Publication
(10) Pub. No.: US 2006/0068670 A1
(43) Pub. Date: Mar. 30, 2006

(54) Electrical insulation laminates and electrical devices containing such laminates

(76) Inventors: David Wayne Anderson, Chester, VA (US); Dariusz Wlodzimierz Kawka, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/956,846

(22) Filed: Sep. 30, 2004

(51) Int. Cl. B32B 5/26; B32B 5/16; B32B 27/12; B32B 27/36

(52) U.S. Cl. 442/391; 442/393; 442/394; 442/395

(57) ABSTRACT

A laminate comprising a layer of elastomeric polyester resin positioned between two nonwoven aramid sheets, and an electrical device such as a transformer comprising that laminate.

### BACKGROUND OF THE INVENTION

1. Field of the Invention

The present invention is directed to an improved electrical insulation laminate of aramid paper and polyester polymer, and an electrical device containing such laminate, the laminate exhibiting reduced stiffness and brittleness such that when the laminate is cut and creased by a die into a complex shaped piece, the crease retains a fold and the cut edge is not sharp to the touch.

2. Description of Related Art

Laminates made from aramid sheets or papers and polyester resin films have been used in transformers wherein the laminate serves as dielectric insulation material. It is desired that such insulative laminates have a combination of physical properties that are especially suited for the needs of transformer manufacturers. In the past, such aramid laminates have incorporated the polyester layer by use of polyester films. However, it has been found that laminates having improved mechanical properties can be obtained by forming the laminates using a liquid polyester resin rather than a pre-formed film.

WO 2004/031466 discloses just such an improved laminate of aramid paper and a polyester polymer layer, preferably a laminate of two aramid papers separated by a polyester polymer layer. In addition, WO 2004/030909 discloses a method of forming a laminate of at least two layers including at least one aramid paper with at least one layer of polymer by calendering opposing surfaces of the aramid paper at different temperatures prior to laminate formation.

When used as electrical insulation in an electrical device, these aramid/polyester laminates are typically first cut into pieces having complex shapes and embossed crease lines using a device that punches out the desired piece using a die. These cut pieces are then folded by hand to the desired shape and are then positioned about the electrical device. If the laminate is too brittle the cut piece can crack when folded, and if the laminate is too stiff, the cut piece will not retain the fold. More importantly, if the laminate is too stiff the edge of the cut piece will be too sharp and multiple cuts can occur to fingers and hands.

What is needed therefore is a laminate material that when creased retains a fold and when cut, the cut edge is not sharp to the touch.

### SUMMARY OF THE INVENTION

The present invention is directed to a laminate comprising a layer of elastomeric polyester resin positioned between two nonwoven aramid sheets, and an electrical device such as a transformer comprising that laminate.

### BRIEF DESCRIPTION OF THE DRAWINGS

FIG. 1 is a simplified representation of the laminate of this invention.

FIG. 2 is a representation of a simplified representation of a piece cut from a sheet of laminate material of this invention that can then be used as electrical insulation in an electrical device.

FIG. 3 is a detail of a typical punched complex shaped piece that can be used in an electrical device, showing cut edges, slits, and creases

### DETAILED DESCRIPTION OF THE INVENTION

The present invention is directed to a laminate comprising a layer of elastomeric polyester resin positioned between two nonwoven aramid sheets.

Aramid Nonwoven Sheet

The laminate of this invention preferably uses nonwoven aramid sheets in the form of an aramid paper. As employed herein the term paper is employed in its normal meaning and it can be prepared using conventional paper-making processes and equipment and processes.

The thickness of the aramid nonwoven sheet or paper is not critical and is dependent upon the end use of the laminate as well as the number of aramid layers employed in the final laminate. Although the present invention employs two layers of nonwoven sheets and one polymer layer, it is understood that there is no upper limit in the number of layers or other materials which can be present in the final article.

As employed herein the term aramid means polyamide wherein at least 85% of the amide (—CONH—) linkages are attached directly to two aromatic rings. Additives can be used with the aramid and, up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the aramids most often used are: poly(paraphenylene terephthalamide) and poly(metaphenylene isophthalamide) with poly(metaphenylene isophthalamide) being the preferred aramid.

The preferred aramid papers used in this invention are typically made by forming a slurry of aramid fibrous material such as fibrids and short fibers which is then converted into paper such as on a Fourdrinier machine or by hand on a handsheet mold containing a forming screen. Reference may be made to Gross U.S. Pat. No. 3,756,908 and Hesler et al. U.S. Pat. No. 5,026,456 for processes of forming aramid fibers into papers.

Generally, once aramid paper is formed it is calendered between two heated calendering rolls with the high temperature and pressure from the rolls increasing the bond strength of the paper. Calendering aramid paper in this manner, however, can also decrease the porosity of the paper, resulting in poorer adhesion of the paper to polymer layers.

The preferred calendered aramid paper used in this invention, therefore, has been made by differential calendering. Such papers are made by calendering the papers in a single calendering step between heated rolls having different temperatures, or the papers may be made by first calendering one surface of the sheet at one temperature and then the opposing surface with a second temperature. This difference in temperature directly results in a difference in the porosity of opposite surfaces of the aramid paper, which translates to improved adhesion of the molten resin to the aramid paper. A temperature difference of at least 20 degrees centigrade is necessary to obtain the advantages of the differential calendaring process, with temperature differences of at least 50 to 100 degrees centigrade, or more, being preferred. It is understood that the temperature in the heated rolls may be below the glass transition temperature of the aramid components in the paper. However, in a preferred mode at least one of the heated rolls will be at or above the glass transition temperature of the aramid.

Elastomeric Polyester Resin

The molten polymer applied to the aramid sheet in this invention is an elastomeric polyester resin. As used herein, elastomeric polyester means a resin comprising a polyester substantially continuous phase and a lower-modulus, polymeric, substantially discontinuous phase.

Preferably, the elastomeric polymer resin is a multi-phase composition comprising a copolyester continuous phase and a low modulus discontinuous phase. Because of the multiphase composition, the resin when used in a laminate has the many of the attributes of an elastomer even if no actual generally accepted elastomer segments are present in the resin. Such a composition is disclosed in U.S. Pat. No. 5,627,236 to Deyrup et al.

Copolyester Continuous Phase. The copolyester continuous phase is present in the multi-phase composition in the amount of 55 to 98 weight percent, based upon 100 weight percent of the multiphase composition, and is derived from about 50 to 95 mole percent of an aromatic diacid monomer, preferably 70 to 90 mole percent; and about 2 to 40 mole percent of an aliphatic diacid monomer, preferably 4 to 14 mole percent. In addition, 90 to 100 mole percent of all the comonomers for the resin are either the aromatic diacid monomer, the aliphatic diacid monomer, or a glycol monomer.

The aromatic diacid monomer is preferably terephthalic acid, isophthalic acid, and/or naphthalaic dicarboxylic acid. The aliphatic diacid monomer is preferably azelaic acid, adipic acid, sebacic acid, dodecanedioic acid or their methylesters, however the aliphatic monomer can all be decane-1,10-dicarboxylic acid, succinic acid, glutaric acid, or derivatives thereof. The glycol monomer is preferably 70 to 100 mol percent ethylene glycol and/or diethylene glycol with the balance, if any, being another glycol such as 1,3-propanediol; 2,4-dimethyl-2-ethylhexane-1,3-diol; 2,2-dimethyl-1,3-propanediol; 2-ethyl-2-butyl-1,3-propanediol; ethyl-2-isobutyl-1,3-propanediol; 1,3-butanediol; 1,4-butanediol; neopentyl glycol; 1,5-pentanediol; 1,6-hexanediol; 1,8-octanediol; 2,2,4,4-trimethyl-1,6-hexanediol; thiodiethanol; 1,2-cyclohexanedimethanol; 1,3-cyclohexanedimethanol; 2,2,4,4-tetramethyl-1,3-cyclobutanediol; polyethylene glycol; polytetramethylene ether glycol; and the like.

In addition to the aromatic diacid monomer(s), the aliphatic diacid monomer(s), and the glycol monomer(s), the resin can contain other comonomer that provide crosslinking, in an amount not to exceed 2 mole percent per 100 mols of diacid, preferably less than 1 mole percent per 100 mols of diacid. Such branching or crosslinking agents include as trimellitic acid, pentaerythritol, glycerol, trimethylol propane, triethylol propane, and the like. The copolyesters may be produced using conventional polyesterification procedures such as described in U.S. Pat. Nos. 3,305,604 and 2,901,460. Of course, esters of the acids (e.g. dimethyl terephthalate) may be used in producing the polyesters also. Preferably, the polyesters are obtained by melt phase polymerization that can be followed by conventional solid state polymerization. Preferably, the intrinsic viscosity of the copolyester is approximately 0.6 to 1.1.

Low Modulus Discontinuous Phase. The substantially discontinuous phase material is present in the resin composition an amount of about 2 to 45 weight percent based upon the weight of the total resin composition, preferably 2 to 35 weight percent. Further, the most preferable composition has 7 to 25 weight percent of the discontinuous phase material, based upon the weight of the total resin composition. The discontinuous phase is present in the final composition as discrete particles having on average a median particle diameter of generally less than about 40 microns, preferably less than about 10 microns, with the most preferred diameter being from about 0.001 to about 2 microns. Further, the ratio of the tensile modulus of the continuous polyester phase material to the discontinuous phase material is greater than 10 to 1, preferably greater than 20 to 1.

The discontinuous phase material is preferably elastomeric however the discontinuous phase can also be non-elastomeric. Useful comonomers in polymerizing discontinuous phase materials (in either random or block polymerization) include ethylene; carbon monoxide; sulfur dioxide; alpha and beta-ethylenically unstaturated carboxylic acids and derivatives thereof; dicarboxylic acids and anhydrides of dicarboxylic acids; metal salts of monocarboxylic or dicarboxylic acids and monoesters of such acids, including those wherein some percentage of the carboxylic acid groups are ionized by neutralization with metal ions, such as sodium or zinc; dicarboxylic acids and monoesters of the dicarboxylic acids neutralized by amine-ended caprolactam oligomers or the like; acrylate esters having 4 to 22 atoms; vinyl esters of acids having from 1 to 20 carbon atoms; vinyl ethers of 3 to 20 carbon atoms; vinyl and vinylidene halides, and nitriles having 3 to 6 carbon atoms; unsaturated monomers having pendant hydrocarbon chains of 1 to 12 carbon atoms capable of being grafted with monomers having at least one reactive group; and unstaturated monomer taken from the class consisting of branched, straight chain and cyclic compounds having from 4 to 14 atoms.

The above described monomers include maleic acid; maleic anhydride; maleic acid monoethyl ester; metal salts of acid monoethyl ester; fumaric acid; fumaric acid monoethyl ester; itaconic acid; vinyl benzoic acid; vinyl phthalic acid; metal salts of fumaric acid monoethyl ester; monoesters of maleic, fumaric or itaconic acids; glycidyl methacrylate; glycidyl acrylate; alkyl glycidyl ether; vinyl glycidyl ether; glycidyl itaconate; phthalic anhydride sulfonyl azide; methyl ester and monooctadecyl ester of phthalic anhydride sulfonyl azide; benzoic acid sulfonyl azide; naphthoic acid sulfonyl azide; naphthoic diacid sulfonyl azide; R-monoesters (and metal salts thereof) of phthalic acid and naphthoic diacid sulfonyl azide; vinyl ethers; vinyl benzoate; vinyl naphthoate, vinyl esters of R-acids, where R is up to 18 carbon atoms; vinyl chloride; vinylidene fluoride; styrene; propylene; isobutylene; vinyl naphthalene; vinyl pyridine; vinyl pyrrolidone; mono-,di-, or tri-chloro styrene; R′-styrene where R′ is 1 to 10 carbon atoms; butene; hexane; octene; decene; hexadiene; norbornadiene; butadiene; isoprene; and divinyl alkyl styrene.

Useful discontinuous phase compositions include the following substantially alternating or substantially random copolymers: ethylene/n-butyl acrylate/methacrylic acid, ethylene/n-butyl acrylate/glycidyl/methacrylic acid or ethylene/methyl acrylate/monoethyl ester of maleic anhydride or 0 to 100 percent neutralized zinc, sodium, calcium, lithium, antimony, or potassium salts thereof; ethylene/methyl acrylate, ethylene/methacrylic acid, or ethylene acrylic acid; ethylene/isobutyl acrylate methacrylic acid; ethylene/methyl acrylate/monoethyl ester of maleic anhydride or zine or sodium salts thereof; ethylene/methyl acrylate/methacrylic acid and zine salts thereof; ethylene/vinyl acetate/methacrylic acid and zinc salts thereof; ethylene/methyl methacrylate/methacrylic acid and zinc salts thereof; ethylene/vinyl acetate/carbon monoxide; ethylene/isobutyl acrylate and a zinc salt of ethylene/isobutyl acrylate/methacrylic acid; ethylene/isobutyl acrylate/carbon monoxide; ethylene/stearyl methacrylate/carbon monoxide; ethylene/n-butyl acrylate/carbon monoxide; ethylene/2-ethyl hexyl methacrylate/carbon monoxide; ethylene/methyl vinyl ether/carbon monoxide; ethylene/vinyl acetate/maleic anhydride; ethylene/vinyl acetate monoethyl ester of maleic anhydride; ethylene/vinyl acetate/glycidyl methacrylate; ethylene/propylene/1,4 hexadiene-g-maleic anhydride; ethylene/propylene/norbornadiene/1,4 hexadiene-g-benzoic acid sulfonyl azide; ethylene/propylene/1,4 hexadiene-g-phthalic anhydride sulfonyl azide; ethylene/propylene/1,4 hexadiene-g-maleic anhydride; ethylene/propylene/1,4 hexadiene-g-maleic anhydride neutralized with amine ended oligomer of caprolactam; ethylene/propylene/1,4 hexadiene/maleic anhydride neutralized with zinc rosinate; ethylene/propylene/1,4 hexadiene-g-fumaric acid; ethylene/propylene/1,4 hexadiene/norbornadiene-g-maleic anhydride; ethylene/propylene/1,4 hexadiene/norbornadiene-g-monoethyl ester of maleic anhydride; ethylene/propylene/1,4 hexadiene/norbornadiene-g-fumaric acid; ethylene/propylene/1,4 hexadiene/glycidyl methacrylate; ethylene/propylene/1,4 hexadiene/norbornadiene-g-phthalic anhydride sulfonyl azide; isobutylene/isoprene-g-phthalic anhydride sulfonyl azide; poly(isobutylene)-g-phthaic anhydride sulfonyl azide; isoprene/phthalic anhydride; natural rubber; ethylene/monoethyl ester of maleic anhydride; butyl acrylate/monoethyl ester of fumaric acid; ethyl acrylate/fumaric acid; epichlorohydrin/ethylene oxide; ethylene/propylene-g-phthalic anhydride sulfonyl azide; ethylene/propylene/5-ethylidine-2-norbornene-fumaric acid; ethylene/propylene/dicyclopentadiene-g-monoethyl ester of maleic acid; ethylene/propylene/5-propenyl-2-norbornene-g-maleic anhydride; ethylene/propylene/tetrahydroindene-g-fumaric acid; ethylene/propylene/1,4-hexadiene/5-ethylidiene-2-norbornene-g-fumaric acid; ethylene/vinyl acetate/CO/glycidyl methacrylate; ethylene/vinyl acetate/CO/glycidyl acrylate; ethylene/methyl acrylate/glycidyl methacrylate; ethylene/methyl acrylate/glycidyl acrylate; and acrylic rubbers.

Another useful discontinuous phase material is a core-shell type polymer having a polymer core and a polymer shell wherein the core and shell have been substantially chemically grafted together. The shell and core are preferably prepared sequentially by emulsion polymerization. The core preferably has a weight average molecular weight of greater than about 8000 and the shell preferably has a weight average weight of about 5000 to 100000 as determined by gel permeation chromatography. Preferred compositions include those polymerized from monomers selected from methyl acrylate; ethyl acrylate; butyl acrylate; 2-ethylhexyl acrylate; decyl acrylate; methyl methacrylate; ethyl methacrylate; hydroxyethyl methacrylate; butyl methacrylate; acrylonitrile; acrylic acid; methacrylic acid; itaconic acid; maleic acid; fumaric acid; acrylic anhydride; methacrylic anhydride; maleic anhydride; itaconic anhydride; fumaric anhydride; styrene; substituted styrene; butadiene; vinyl acetate; other C1 to C12 alkyl acrylates and methacrylate; and the like.

The preferred elastomeric polyester resin is a multi-phase composition comprising:
a) 55 to 98 weight percent (based upon 100 weight percent of the multiphase composition) of a copolyester continuous phase, the copolyester being derived from:
   i) an aromatic diacid from the group consisting of: terephthalic acid, isophthalic acid, naphthalaic dicarboxylic acid and mixtures thereof, and
   ii) 60 to about 98 mole percent (based upon 100 mole percent diol) of ethylene glycol and the balance being diethylene glycol,
      wherein the copolyester is derived only from the diacid, the diol and 0-2 moles of a branching agent per 100 moles diacid;
b) 2 to 45 weight percent (based upon the weight of the multi-phase composition) of a substantially discontinuous phase comprising a low modulus ethylene copolymer.

Mixing of the materials for the continuous phase and the discontinuous phase can be accomplished by a variety of conventional melt compounding devices, such as a single screw extruder operating at a temperature sufficient to cause the components to melt flow. Preferably, the compounding temperature should be less than about 270 degrees Celsius and the extrusion temperature of the final material should be preferably less than about 280 degrees Celsius. Pre-compounding of some compositions may not be necessary and the extrusion can be conducted directly in a single step. The discontinuous material can alternatively be added immediately after polymerization of the continuous material by injecting the discontinuous material into the polyester melt stream and then mixing by static mixers.

As is generally disclosed in U.S. Pat. No. 5,627,236, melt blending of the resin can also be accomplished in a closed system such as a multi-screw extruder such as a Werner Pfleiderer extruder having 2-5 kneading blocks and at least one reverse pitch to generate high shear, or the blending can be accomplished in other devices such as a Brabender, Banbury Mill, or the like. Alternate methods of making the blends include coprecipitation of the materials from solution and blending; or by dry mixing of the materials. The blend can then be melt fabricated by extrusion.

Additives

The resin may also contain additives to enhance performance characterics. For example, crystallization aids, impact modifiers, surface lubricants, denesting agents, stabilizers, antioxidants, ultraviolet light absorbing agents, metal deactivators, colorants such as titanium dioxide and carbon black, nucleating agents such as polyethylene and polypropylene, phosphate stabilizers, and the like.

In addition, the resin may contain minor amounts of other thermoplastic resins or other known additives to thermoplastic resins, such as antistatic agents, flame retardants, coloring agents such as dyes and pigments, lubricants, plasticizers, nucleating agents, and inorganic fillers. The inorganic fillers can include one or more of such things as mica, carbon black, graphite, silicates such as silica, quartz powder, glass beads, milled glass fiber, glass balloons, glass powder glass flakes, calcium silicate, aluminum silicate, kaolin, talc, clay, diatomaceous earth and wollastonite, metals in the form of various oxides, sulphates, silicates, carbonates, carbides, nitrides, powders, foils and the like.

Laminates of this Invention

The laminate of this invention comprises a layer of elastomeric polyester resin positioned between two nonwoven aramid sheets. Preferably, the resin contacts the two nonwoven aramid sheets and the resin thickness is greater than any one nonwoven sheet in the laminate. Preferably each of the two nonwoven aramid sheets is adjacent and attached to either side of the layer of elastomeric polyester resin.

The laminates of this invention have a thickness of from 5 to 25 mils, preferably from 7 to 15 mils, and preferably have a modulus of elasticity of less than 400 Kpsi, and more preferably less than 370 Kpsi. Further, it is believed that laminates of the invention preferably have a lower bound of modulus of elasticity of about 100 Kpsi.

These laminates further have an elongation at break within about +/−20 percent of that of the original aramid paper, which is generally in the range of 5 to 15%. This equivalence means that when the laminate is stretched such that the aramid paper fails, the entire laminate will fail, preventing the use of the laminate with damaged paper layers.

Because of the crystalline nature of some polyester polymers, the edges of the laminate after slitting and/or punching can be sharp to the touch. The final laminate of this invention, and cut pieces of such laminate, do not exhibit this sharpness or propensity towards cutting the hands of manufacturing personnel who may handle this material.

A further advantage of the laminate of this invention is that it is a flexible laminate that will retain a fold. Stiff structures are not desirable and the laminate of this invention exhibits reduced stiffness and is easier for the manufacturing personnel to fold, wrap and crease. The laminate can be cut into smaller pieces by use of a die that is punched into the laminate material. The die preferably includes cutting edges for cutting and slitting the material and other edges for creating embossed creases or fold lines in the cut piece. These smaller pieces can then be used as electrical insulation by folding the cut pieces around metal parts in electrical devices. The laminate can also be slit or cut into tape-like structures and wound around small diameter coils of electrical wire.

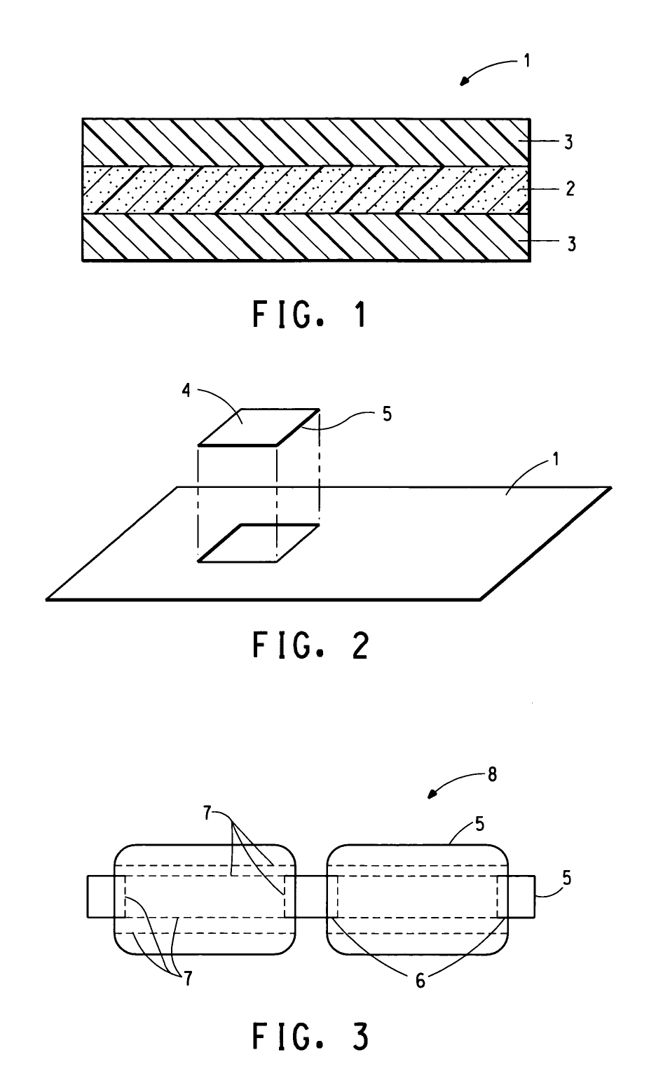

A cross-sectional view of the preferred laminate of this invention is shown in FIG. 1. Laminate 1 is shown with a layer of elastomeric polyester resin 2 with a layer of aramid paper 3 adjacent to, coextensive with, and contacting either side of the polyester resin. FIG. 2 is a simple illustration of a sheet of laminate 1 with cut piece of the laminate 4 having been punched out. FIG. 3 is a detail of a typical punched complex-shaped piece 8 having cleanly cut edges 5, cleanly cut slits 6, and creasing lines 7 embossed on the piece.

Process for Making Laminate

While not intended to be limiting, one method of making the laminates of this invention is by extruding molten polymer between two calendered aramid papers followed by pressing and quenching to form the laminate. The molten resin can be extruded onto the aramid sheets in any number of ways. For example, the resin may be extruded onto one calendered aramid sheet and then covered with a second aramid sheet and then laminated using a press or laminating rolls. In a preferred method the molten resin is supplied to a slotted die from an extruder. The slotted die is oriented so that a sheet of molten resin is extruded in a vertically downward fashion to a set of horizontal laminating rolls. Two supply rolls of aramid paper provide two separate webs of aramid paper to the laminating rolls and both webs and the sheet of molten resin all meet in the nip of the laminating rolls with the resin positioned between the two webs. The laminating rolls consolidate the webs and resin together; the consolidated laminate is then quenched by running the laminate through the nip of another set of cooled rolls. Alternatively, the horizontal laminating rolls may be cooled to both consolidate and quench the laminate. The laminate may then be cut into sheets of appropriate size as needed for the application. The sheets can then be die cut into smaller pieces as needed as insulation in an electrical device.

In the following examples, the Modulus of Elasticity is measured per ASTM D828 and this physical property was used as an indicator of relative stiffness.

### EXAMPLE

This example illustrates the properties of the laminates of this invention. The laminates were made as follows. Aramid paper comprised of 45% poly (m-phenylene isopthalamide) floc and 55% poly (m-phenylene isopthalamide) fibrids was made using conventional Fourdrinier paper making processes and equipment. The paper was then calendered at 800 pli (1400 n/cm) between two rolls operating at different surface temperatures, specifically 360 degree centigrade and 250 degrees centigrade, to make differential calendered papers for lamination. Polymer was applied to the more porous surfaces of the aramid sheets by extrusion lamination of polymer between the two papers and quenching the laminates. The laminates were produced using 2 mil (0.05 mm) thick meta-aramid papers and a 5 mil (0.13 mm) thick polymer layer. The polymer of Item 1 of this invention was a modified PET polyester employing a 0.70 inherent viscosity polyethylene terephthalate containing 14% ethylene methacrylic acid copolymer neutralized with metal cation salts. Comparative Item A was a single-phase copolymer PET polyester employing 0.65 inherent viscosity polyethylene terephthalate containing 14% branched copolymer and 17% isomeric copolymer. Comparative Item B was a high molecular weight PET polyester employing a 0.80 inherent viscosity polyethylene terephthalate. Samples of these extrusion laminates were then die-cut by punching the laminate with a flexible steel rule die having a combination of cuts, notches and compressed lines to assist while manually folding the punched part. The starting material was tested using ASTM D828 to determined the Modulus of Elasticity and the die-cut shapes were evaluated for edge sharpness.

TABLE

| | | Modulus of |
|---|---|---|
| Sample | Edge Sharpness | Elasticity (Kpsi) |
| 1 | Edge is clean but not | 320 |
| | sharp; does not cause | |
| | finger cuts | |
| A | Edge is clean but is | 440 |
| | unacceptably sharp; | |
| | causes multiple finger | |
| | cuts | |
| B | Edge is clean but is | 420 |
| | unacceptably sharp; | |
| | causes multiple finger | |
| | cuts | |

What is claimed is:

1. A laminate comprising a layer of elastomeric polyester resin positioned between two nonwoven aramid sheets.

2. The laminate of claim 1 having an overall thickness in a range from of 5 to 25 mils (0.13 to 0.61 mm).

3. The laminate of claim 1 wherein the thickness is in a range from 7 to 15 mils (0.18 mm to 0.38 mm).

4. The laminate of claim 3 wherein the thickness of the layer of polyester resin in the laminate is greater than the thickness of any individual nonwoven sheet in the laminate.

5. The laminate of claim 1 wherein the resin contacts the two nonwoven aramid sheets.

6. The laminate of claim 5 wherein each of the two nonwoven aramid sheets is adjacent and attached to either side of the layer of elastomeric polyester resin.

7. The laminate of claim 1 wherein the nonwoven aramid sheet comprises aramid paper.

8. The laminate of claim 7 wherein the aramid paper is a differentially calendered paper.

9. The laminate of claim 7 wherein the aramid paper comprises aramid fiber and fibrids.

10. The laminate of claim 7 wherein the aramid paper includes metaphenylene isophthalamide floc.

11. The laminate of claim 1 wherein the elastomeric polyester is a resin comprising a polyester substantially continuous phase and a lower-modulus, polymeric, substantially discontinuous phase.

12. The laminate of claim 1 wherein the elastomeric polyester resin is a multi-phase composition comprising:
a) 55 to 98 weight percent (based upon 100 weight percent of the multiphase composition) of a copolyester continuous phase, the copolyester being derived from:
i) an aromatic diacid from the group consisting of: terephthalic acid, isophthallic acid, naphthalaic dicarboxylic acid and mixtures thereof, and
ii) 60 to about 98 mole percent (based upon 100 mole percent diol) of ethylene glycol and the balance being diethylene glycol,
wherein the copolyester is derived only from the diacid, the diol and 0-2 moles of a branching agent per 100 moles diacid;
b) 2 to 45 weight percent (based upon the weight of the multi-phase composition) of a substantially discontinuous phase comprising a low modulus ethylene copolymer.

13. The laminate of claim 12 wherein the copolyester comprises a branching agent which is a member of the group consisting of trimellitic acid, pentaerythritol, glycerol, trimethylol propane, triethylol propane and mixtures thereof.

14. An electrical device containing the laminate of claim 1.

15. An electrical device containing the laminate of claim 6.

16. An electrical device containing the laminate of claim 12.
